(19) United States
(12) Patent Application Publication
(10) Pub. No.: US 2014/0259397 A1
(43) Pub. Date: Sep. 18, 2014

(54) METHODS AND APPARATUS FOR SECURING ACTUATORS TO STRUCTURES

(71) Applicant: CHINA MOTORS AND COMPONENTS, INC., Delavan, WI (US)

(72) Inventor: Scott A. McReynolds, McHenry, IL (US)

(21) Appl. No.: 14/211,762

(22) Filed: Mar. 14, 2014

Related U.S. Application Data
(60) Provisional application No. 61/798,472, filed on Mar. 15, 2013.

(51) Int. Cl. A47C 19/04; F16C 11/04; A47C 19/02

(52) U.S. Cl. CPC A47C 19/04; A47C 19/02; F16C 11/04
USPC 5/412; 29/453; 403/119

(57) ABSTRACT

Various methods and apparatus are disclosed herein for securing an actuator to a structure. In one form the apparatus includes a first clamp member connected to an actuator and having a first mating structure, and a second snap-fit clamp member having a second mating structure that engages and mates with the first mating structure when the second clamp member is snapped onto the first clamp member to form a clamp that secures the actuator to a structure and encloses the structure so that the actuator is easily and properly connected to the structure.

### CROSS REFERENCE TO RELATED APPLICATION

The application claims the benefit of U.S. Provisional Application No. 61/798,472, filed Mar. 15, 2013, and is hereby incorporated herein by reference in its entirety.

### FIELD

The present invention relates generally to methods and apparatus for securing actuators to structures, and more specifically to methods and apparatus for attaching linear actuators to articulated furniture.

### BACKGROUND

Actuators have been used for decades to move or control mechanisms or systems. For example, linear actuators have been used to create articulating furniture such as moving chairs, couches and beds (or movable foundations for same). U.S. Pat. No. 4,678,231 issued to Chizek on Jul. 7, 1987, U.S. Pat. No. 5,094,508 issued to Bathrick et al. on Mar. 10, 1992, and U.S. Pat. No. 5,219,204 issued to Bathrick et al. on Jun. 15, 1993 illustrate linear actuators that are used in adjustable chairs. U.S. Pat. No. 3,921,230 issued to Hanning et al. on Nov. 25, 1975, U.S. Pat. No. 4,381,571 issued to Elliott on May 3, 1983, U.S. Pat. No. 4,928,332 issued to Ogden et al. on May 29, 1990, U.S. Pat. No. 5,063,623 issued to Bathrick et al. on Nov. 12, 1991, U.S. Pat. No. 5,438,723 issued to Carroll on Aug. 8, 1995, U.S. Pat. No. 5,579,550 issued to Bathrick et al. on Dec. 3, 1996, and U.S. Pat. No. 6,061,852 issued to Bathrick et al. on May 16, 2000 illustrate linear actuators that are used in adjustable beds.

Over the years, improvements have been made to the designs of these systems and to the linear actuators themselves. For example, U.S. Pat. No. 5,542,744 issued to Bathrick on Aug. 6, 1996 illustrates a linear actuator or drive having pre-determined “extended” and “retracted” positions to assist in the repair or replacement of linear drives in the field. However, as can be seen in viewing any of these references, little to no effort has been made to improve and simplify the way in which such actuators are connected to their respective furniture frames or foundations (both during initial installation and/or during repair or replacement). Rather, the actuators are normally connected to furniture frames or foundations via brackets and pins or brackets and bolts that allow the actuator to pivot throughout its operation.

One problem with conventional mounting means for linear actuators is that their assembly requires the bolting or pinning of the actuator to the furniture via a bracket or clamp. These configurations add time to the assembly and/or repair of the furniture because the bolting or pinning steps are not easy to do and often require the person assigned with such tasks to work in tight spaces that do not lend themselves well to the use of tools or even movement of ones' arms, hands or fingers to complete the bolting or pinning action. For example, conventional actuator mounts for articulated beds are illustrated in FIGS. 8A-9C. As illustrated in these drawings, the bed (10) usually has a frame (20) with crossbars (22), (24) to which the actuator (40) is anchored on one end (42) via the pinned or bolted bracket or clamp arrangement mentioned above, and connected to tubular rocker shafts (26), (28) via the distal end of the drive tube (46) located on the opposite end (44) of the actuator (40). The rocker shafts (26), (28) have respective rocker arms (26a), (26b) and (28a), (28b) which rotate along with the rocker shaft to move portions of the furniture either directly or indirectly (e.g., through movement of a foundation, etc.). Thus, operation of the linear actuator (40) in one direction drives the drive shaft (46) to rotate the rocker shafts (26), (28) in one direction of rotation and thereby rotate the rocker arms (26a), (26b) and (28a), (28b) into the position illustrated in FIG. 8B. While operation of the linear actuator (40) in the opposite direction rotates the rocker shafts (26), (28) in the opposite direction of rotation and returns the rocker arms (26a), (26b) and (28a), (28b) to the position illustrated in FIG. 8A.

As is best illustrated in FIGS. 9A-C, conventional actuators connect the actuator (40) to the frame crossbars (22), (24) via a clamp formed by U-shaped clevis clamp member (50) and clevis bushing (52), which are held together via clevis pin (54). In the form illustrated, the clevis pin (54) is a simple pin secured to the actuator (40) via a cotter pin, such as a split pin or an R-clip (note: in alternate forms, the pin may be a partially threaded bolt that is secured to the actuator (40) via a nut). The clevis bushing (52) is connected to a mount (60a) that is formed from the gearbox or transmission housing (60) of the actuator (40). A motor (70) is connected to the gearbox (60) and powered via power cord (62) which is secured to the gearbox (60) using conventional strain relief techniques and connects to a power source, such as an AC mains supply or a DC power supply. The motor output shaft turns a worm gear which engages the gears of gearbox (60), and the gears of the gearbox (60) in turn drive a screw, such as an Acme screw with a trapezoidal thread form, whose rotation moves a nut and connected drive tube (46) between extended and contracted positions.

As FIGS. 8A-B illustrate, in many furniture applications there is not a lot of working room for the installer to reach in and connect the actuator (40) to the furniture frame. This is equally true for service personnel who are tasked with repairing the actuator (40) in the field and need to remove and reattach the clevis pin from time-to-time. In fact, if care is not taken when initially installing the actuator, such a repair may be made extremely difficult if not impossible because access to both sides of the clevis pin (54) may not be readily available. Thus, in some instances it may be difficult or impossible to reach and remove the cotter pin or nut that secures the clevis pin (54) to the actuator (40). In other instances, it may be difficult or impossible to remove the clevis pin (54) because there is not enough space or room to remove the pin (54) from the mount (60a). In still other instances, both situations may be presented.

Other problems associated with conventional actuator mounts are that current designs require additional material and parts, which in turn drives up cost and the amount of time it takes to assemble or repair conventional actuators. For example, in actuators that are connected using the clevis pin configuration discussed above, the extra costs associated with the pin and the means for securing the pin (e.g., cotter pin or nut) are incurred. In addition, the extra time it takes to insert the pin and secure the pin are incurred during installation and the extra time it takes to unsecure and remove the pin and then replace and re-secure the pin are incurred during repair.

An attempt has been made to make an actuator that connects without the need for a pin as illustrated in U.S. Pat. No. 7,900,302 issued to Long on Mar. 8, 2011, however, this actuator connection (152) requires the installer and/or repairer to exert an excessive amount of force on the actuator in order to make a proper connection to the bed frame. Specifically, the actuator mount or connector (152) has a C-shape that's opening is smaller than the diameter of the frame tube it is connected to and requires the installer or repairer to push hard enough to flex the ends of the C shape to open wide enough to fit the frame tube. The ends of the C shape then return to their normal position thereby securing the actuator to the bed frame member. Another problem with this design (152) is that it can be hard to tell if the actuator has been fully installed or re-connected properly due to the mount design being open on one end and not connecting all the way around the bed frame tube that the actuator connects to as illustrated in the drawings. An actuator that is not fully installed on the bed frame member may slip off due to the cam action of the flexing ends of the C shape mount or connector. Still another problem with such an open actuator mount (152) is that the actuator can be left slightly askew when connected to the bed frame tube (rather than being perfectly square or normal to the tube) which can prove problematic when the actuator is put into operation and is exposed to the forces that the actuator is subject to when moving portions of the furniture. For example, if left askew, the actuator may continue to move further away from the desired position of being normal to the bed frame tube and can prevent the actuator from moving portions of the furniture as far as intended and/or, in worst case scenarios, can lead to the actuator snapping off the bed frame tube to which it is connected or bending or denting portions of the actuator and/or bed frame tube due to the irregular positioning of the actuator.

Thus, a need exists for improved methods and apparatus for fastening actuators to structures and, more particularly, for fastening linear actuators to articulated furniture.

### BRIEF DESCRIPTION OF THE DRAWINGS

The above and other aspects, features and advantages of exemplary embodiments of the present invention will be more apparent from the following more particular description thereof, presented in conjunction with the following drawings.

FIGS. 1A-B are partial perspective views of an exemplary embodiment of articulated furniture using an actuator in accordance with at least one embodiment of the invention, with FIG. 1A illustrating the furniture from above in a moved or raised state and FIG. 1B illustrating a bottom perspective view of the furniture in its initial or lowered state;

FIGS. 2A-B are partial perspective views of an exemplary embodiment of the snap-fit clevis clamp disclosed herein in accordance with at least one embodiment of the invention, illustrating the clamp secured to a torque tube from above and below the torque tube, respectively;

FIGS. 3A-B are side elevation views of the snap-fit clevis clamp of FIGS. 2A-B, illustrating the clamp in an exploded or released position and a clamped or secured position, respectively;

FIGS. 4A-C are top, side and end elevation views of the generally U-shaped snap-fit clevis clamp member of FIGS. 2A-3B, respectively;

FIGS. 4D-E are cross-sectional and enlarge views taken along line 4D-4D in FIG. 4C and from position 4E in FIG. 4B, respectively;

FIG. 5 is an exploded view of an exemplary embodiment of the actuator of FIGS. 2A-4C in accordance with at least one embodiment of the invention;

FIG. 6 is a perspective view of an alternate embodiment of a clevis bushing mount illustrating an alternative guide structure that may be used for aligning and guiding the bosses or protrusions extending from the clevis clamp arms into their mating recesses (shown without the clevis bushing for convenience);

FIGS. 7A-C are exploded, perspective and cross-sectional views of an alternate an exemplary embodiment of the snap-fit clevis clamp disclosed herein in accordance with at least one embodiment of the invention, illustrating an alternate actuator mount and clamp wherein the mount has male mating members and the clamp has corresponding female mating members that engage one another to secure the actuator to a torque tube;

FIGS. 8A-B are perspective views of conventional articulating furniture using linear actuators for movement and showing the furniture in an initial or retracted state and in a moved or extended state, respectively; and

FIGS. 9A-C are side elevation, top and end elevation views, respectively, of a conventional actuator using a clevis clamp secured via a pin.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of the invention and the exemplary embodiments discussed herein. The scope of the invention should be determined with reference to the claims.

Reference throughout this specification to “one embodiment,” “an embodiment,” “some embodiments” or similar language means that a particular feature, structure, or characteristic described in connection with the embodiment is included in at least one embodiment of the present invention. Thus, appearances of the phrases “in one embodiment,” “in an embodiment,” “some embodiments”, “in one form”, “in another form”, and similar language throughout this specification may refer to the same embodiment and/or may refer to separate or alternate embodiments as well. Furthermore, the described features, structures, or characteristics of the invention may be combined in any suitable manner in one or more embodiments. In the following description and the materials incorporated by reference, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Turning now to FIGS. 1A-7C, improved methods and apparatus for securing actuators to structures are disclosed herein and will now be discussed in more detail. In FIGS. 1A-B, an exemplary embodiment of articulated furniture using actuators in accordance with at least one embodiment of the invention is illustrated. More particularly, FIG. 1A illustrates an articulated bed 110 having a two-point articulation system and/or a three motor bed), moved into a second or moved position where an occupant or patient's head and knees and/or legs would be elevated. FIG. 1B illustrates the articulated bed 110 tipped over so that the bed frame 120 and actuators 140 are better visible and illustrates the bed frame or foundation in an initial or unmoved position where the occupant or patient would be lying flat on the bed 110. With this design, the bed foundation is broken into four pieces or plates that are pivotally hinged to one another so that when the two-point articulation system folds in the two spots driven by the actuators 140 a more comfortable lounging position can be obtained.

Unlike the prior art illustrated in FIGS. 8A-B, in the form illustrated in FIGS. 1A-7C, the articulating bed 110 combines the crossbars and rocker shafts into single structures, such as torque tubes or shafts 122, 124. The torque tubes 122, 124 are rounded on at least one end and provide a surface to which the first end 142 of actuators 140 may be mounted and pivot upon and include brackets to which the second end 144 and more specifically, the drive shaft or tube 146 of actuator 140 is connected for moving or rotating the torque tube. The motor 170 of actuator 140 is similarly powered via power cables 162. Rocker arms extend from the opposite ends of the torque tubes 122, 124 and are used to move portions of the furniture 110. The structure of some of the more typical conventional articulating beds is discussed in U.S. Pat. No. 7,900,302 issued to Long on Mar. 8, 2011 (“the '302 patent”) the disclosure of which is incorporated herein by reference in its entirety as it pertains to those conventional articulating bed structures (and not the snap-fit connectors claimed in the '302 patent) so that this disclosure does not need to be repeated here.

Unlike the '302 patent however (as well as other conventional actuators and actuator driven articulated furniture), the embodiments disclosed herein depict a completely different snap-fit clamp structure that is used to secure the actuators 140 to the torque tubes 122, 124. More particularly and as best illustrated in FIGS. 2A-4C, a generally U-shaped snap-fit clevis clamp member 150 is provided that secures the actuator 140 to the furniture frame 120 without the need for a pin like that shown in the prior art of FIGS. 7A-8C. The arms 150a, 150b of snap-fit clevis clamp member 150 preferable have an integrated securing structure, such as projections or bosses 150c, 150d, which cooperate and mate with corresponding structures located in the actuator mounts 160a, such as apertures or recesses defined therein, to form an actuator mount or connector that connects entirely around the torque tubes 122, 124 so that the actuator is held perpendicular to the torque tubes 122, 124 and so that there can be no question when the actuator is properly connected to the torque tubes 122, 124. This two piece snap-fit clamp design also is easy to install for initial setup purposes and is easy to remove or release and re-install for repair or replacement purposes.

In a preferred form, the internal radius of curvature of the snap-fit clevis clamp member 150 matches the internal radius of curvature of the clevis bushing 152 so that when the clamp member 150 is secured to the actuator 140 as illustrated in FIG. 3B, the two structures 150, 152 form a structure with a constant or generally constant inner diameter that is only slightly larger than the outer diameter of the torque tube 122, 124 so that the actuator 140 can be easily secured to the frame 120 of furniture 110. In addition, the distal ends of clamp arms 150a, 150b have gripping structures, such as raised flanges 150e, 150f, which an installer or repair person can grasp to easily disconnect the bosses 150c, 150d from their mating recesses or notches located in the actuator mount 160a. This allows for the clevis clamp member 150 to easily be removed without the need to remove a cotter pin or nut and reduces the space needed between the clamp member arms 150a, 150b and the surrounding environment because no additional pin needs to be removed from the mount 160a and clamp member 150 in order to disconnect the actuator 140 from the furniture 110, nor does excessive force have to be applied to remove the actuator 140.

In the form illustrated in FIGS. 3A-B, the clevis bushing 152 has a general U-shape when looking at the bushing from the side and ends in abutting surfaces 152a, 152b that abut shoulder surfaces 150g, 150h of the clevis clamp member 150. The abutting surfaces act as a shoulder or stop that shoulder members 150g, 150h will contact once the clamp has been fully inserted onto the mount 160a of actuator 140. In addition, the clevis bushing will preferably have a U-shape cross section due to upstanding semi-annular walls as best illustrated in FIG. 3A. These upstanding walls or lips form a first channel 152c which is used to help connect the bushing 152 to actuator mount 160a and prevent lateral movement of the bushing 152 with respect to the mount 160a. In a preferred form, the channel 152c also forms a guide for aligning and directing the clamp arms 150a, 150b into position as the clamp member 150 is inserted onto the actuator mount 160a (e.g., in tongue and groove or mortise and tenon fashion). Thus, as the clamp arms 150a, 150b enter over the actuator mount 160a, the bushing 152 (and more specifically the bushing channel 152c) guide the clamp arms 150a, 150b so that the projections 150c, 150d align with their respective mating openings or bores defined by the actuator mount 160a so that the projections may fall into place into the openings and the remaining inner surfaces of the clamp arms 150a, 150b fall flush with the outer surface of the actuator mount 160a.

In the form illustrated in FIGS. 2A-3B, the clamp member 150 and bushing 152 are preferably made of a material that can withstand the wear that the rotation of torque tubes 122, 124 will cause on the inner surfaces of the clamp member 150 and bushing 152. For example, in one form, these components are molded out of nylon, natural color and free of porosity and flash. A central rib may be added, like rib 150o illustrated in FIGS. 1A-4D in order to stiffen the clamp member 150 or provide the desired amount of resiliency so that when the clamp member 150 is removed from mount 160a, the clamp member 150 will return to the desired shape for same. The projections 150c, 150d of clamp member 150 are preferably hollow in shape, like sleeves, to save on material in the injection molding process and taper from a smaller height near the open end of the U-shaped clamp member 150 to a larger height further away from the open end of the clamp member 150 to provide projections 150c, 150d that have a smaller leading edge so that the clamp member is easier to insert onto the bushing 152 and mount 160a and a larger trailing edge that securely nests in the mating recesses of mount 160a in male/female mating type fashion which hinders inadvertent removal of the clamp member 150 from mount 160a. An additional benefit to such hollow bosses is that a pin could be inserted into the clamp member 150 and mount 160a in applications where such an added or extra measure of securing the actuator to a structure is needed, thereby providing a clamp with two separate securing features (e.g., a first snap-fit securing feature, and a second fastener mounted securing feature such as a bolt or pin). Alternatively, and as illustrated in FIGS. 4A-E, the snap-fit clamp 150 may be provided with solid mating members or bosses instead of hollow versions like those in FIGS. 2A-3B.

It should be understood that in alternate embodiments, other cooperating or mating structures may be used to secure the snap-fit clamp member 150 to the mount 160a (e.g., different sizes, shapes, locations or positioning, etc.). For example, different types of tongue and groove, mortise and tenon, ball and detent or dowel and jig type structures may be used to achieve such a mating configuration. In one form the clamp member arms 150a, 150b may define hooks that engage a shoulder formed on the mount 160a (e.g., shoulders formed by a raised lip, shoulders formed by notches defined by the mount 160a, etc.) to secure the clamp member 150 to the mount 160a and bushing 152. In such other embodiments, the distal ends of clamp arms 150a, 150b may have gripping structures, such as the raised flanges 150e, 150f discussed above, which an installer or repair person can grasp to easily disconnect the bosses 150c, 150d from their mating recesses or notches located in the actuator mount 160a. Alternatively, other embodiments may be provided with alternate gripping structures or even without such gripping structures if desired.

In other forms, the projection defined by the clamp member arms 150a, 150b may be positioned on the opposite side of each arm so that the projections or protrusions extend out and/or away from one another rather than pointing in and/or toward one another as illustrated in FIGS. 3A and 4B-C. For example, in one form, the mount 160a and/or bushing 152 may define a socket into which the arms 150a, 150b are disposed to mate and secure the clamp member 150 to the actuator 140. In other forms, the clamp member 150 and bushing 152 or mount 160a may be designed so that the arms 150a, 150b are inserted into the inner side of the bushing and mount. For example, the channel 152c of bushing 152 may be formed on the inner surface of the bushing 152 or mount 160a and the structures may be designed so that the projections 150c, 150d mate with recesses defined by the inner surfaces of the bushing 152 or mount 160a. In a preferred version of such forms, the bushing 152 or mount 160a would be structured so that when the clevis clamp member 150 is connected to the bushing 152 or mount 160a, the structures collectively would continue to define an opening with a uniform inner diameter like that shown in the embodiment of FIGS. 3A-B. In still other forms, the snap-fit clamp member 150 may be designed with alternative male and female structures that mate with respective female and male structures on the bushing 152 or actuator mount 160a, if desired.

In FIG. 6, an alternate embodiment of mount 160a is illustrated in which an alternate guide channel is illustrated. For convenience, features of this embodiment common to features of the above embodiments will be referenced using the same two-digit reference numeral used above, but with prefix “2” to distinguish one form from others. In the form illustrated, mount 260a defines recessed channels 260d, 260e on opposite sides of the mount 260a adjacent the mating recesses 260b, 260c defined by mount 260a. The recessed channels 260d, 260e serve to align and guide the projections 150c, 150d into their mating recesses 260b, 260c (which are similar to the recesses defined by mount 160a in FIGS. 1A-4E. In one form, guide channels 260d, 260e may be used to compliment channels 152c of the clevis bushing 152 discussed above as a second form of guide. In other forms, guide channels 260d, 260e may be used in lieu of channel 152c of clevis bushing 152. In still other embodiments, the mount 260a itself may be provided in a material capable of handling the wear associated with the torque tubes 122, 124, such as nylon, and no additional clevis bushing 152 is used. It should also be understood that in other forms, the channel may not be recessed, but rather may be defined by upstanding walls or lips extending from the outer surface of the mount 160a or a combination of upstanding walls and recessing may be used to define channels 260d, 260e.

In a preferred form, the guide channels 260d, 260e will be used in conjunction with channels 152c of clevis bushing 152 to guide the projections 150c, 150d from the moment the clamp member arms 150a, 150b are inserted over the clevis bushing 152 and mount 260a. This allows for controlled movement of the clamp member 150 from start to finish. In other forms, the first guide 152c may guide the projections 150c, 150d for a portion of the clamp member's travel as it is inserted onto the mount 160a and the second guide channels 260d, 260e may be used to guide the projections 150c, 150d for a second portion of the clamp member's travel. These guides may be configured to provide back-to-back alignment and guidance without a gap so that the projections 150c, 150d movement is continuously guided. Alternatively, a gap may be provided between the guides so that a first and second stage of guidance is provided, if desired (e.g., a two-stage guiding member or guide).

In still other forms, and as mentioned above, it should be understood that the cooperating structures of the clamp member 150 and mount 160a may be reversed if desired. For example, in one form, the projections may extend from opposite sides of mount 160a and engage mating recesses defined by the arms 150a, 150b of clamp member 150. In such alternate forms, the projections defined by the mount 160a would preferably be tapered from a smaller height near the opening of the mount 160a or bushing 152 to a larger height away from the opening of the mount 160a or bushing 152. This would continue to allow the clamp member 150 to be installed easily on the mount 160a, but securely mate the projections and corresponding recesses so that the clamp member 150 cannot be removed unless desired.

An exemplary embodiment of such an alternate snap-fit clamp design is illustrated in FIGS. 7A-C. In keeping with the above practice, items that are similar to those already discussed will use the same “two-digit” reference numeral but with the addition of the prefix “3” in order to distinguish one embodiment from the other. In this form, the bushing 352 and bushing mount 360a are integrated into a single generally U-shaped structure. Projecting from the exterior surfaces of the U-shaped mount member 360a are male projections 360f, 360g which will serve mating structure roles similar to the bosses 150c, 150d discussed above. The clamp member 350 remains generally U-shaped having first and second arms 350a, 350b; however, recesses or channels 350i, 350j are defined by the inner surfaces of the arms 350a, 350b which will serve corresponding mating structure roles similar to the channel 152c discussed above. More particularly, the male projections 360f, 360g will be aligned with and inserted into respective channels 350i, 350j when the clamp 350 is inserted onto mount 360a. These channels 350i, 350j will help guide the clamp member 350 as they are positioned or slid into engagement with projections 360f, 360g and will further help ensure that the clamp 350 is firmly connected to mount 360a and that the actuator 340 is held square to the tube to which it is connected via the clamp members.

As can best be seen in the cross-sectional view of FIG. 7C, the channels 350i, 350j will preferably define recesses or pockets within which the projections 360f, 360g are disposed and will further define shoulders 350k, 350l which are used to capture and secure the projections 360f, 360g (and therefore the clamp member 350 itself) once the clamp member 350 is fully inserted onto the mount 360a. The gaps that exist between the first and second ends 350a, 350b and the mount 360a at the distal ends of the clamp member 350 provide gripping surfaces that the user may grasp to release the projections 360f, 360g of clamp member 350 from their respective pockets or channels 350i, 350j.

In addition to the above, the snap-fit clamp member 350 further includes a tongue member 350m which cooperates with channels 350i, 350j to form mating recesses for receiving the distal ends of the U-shaped mount 360a as illustrated in FIG. 7C. The distal ends of U-shaped mount 360a are preferably rounded, tapered or bell-mouthed to make it easier for the mount 360a to receive the tube to which the actuator is to be mounted. As with earlier embodiments, the radius of curvature of the internal surfaces of clamp member 350 (mainly the tongue member 350m) and mount 360a are very close if not identical so that the clamp makes a solid connection around the tube the actuator is connected to so that it securely holds the actuator to the tube and, preferably, perpendicular to the tube. As illustrated in FIG. 7C the radius of curvature of the U-shaped mount 360a is such that a slight lip 360h is created on opposite inner-sides of the U-shaped mount arms in order to create a friction fit between the mount 360a and the tube to which it is connected so that the mount 360a and actuator will resist falling off the tube while clamp member 350 is connected to mount 360a.

In the form illustrated in FIGS. 7A-C, both the mount 360a and clamp member 350 are made from a resilient material capable of withstanding the friction the actuator is subjected to when connected to articulating furniture. For example, in a preferred form, both the mount 360a and clamp member 350 will be molded out of nylon which is a departure from the cast metal structure used for the mount in prior embodiments. The mount will preferably be connected to the actuator via fasteners extending through the four openings illustrated in the perimeter of the bracket in FIG. 7B so that the opening in the bottom of the mount 360a may be used to retain internal components of the actuator (e.g., drive tubes, drive tube housings, threaded screws, etc.) if desired. It should be understood, however, that in alternate embodiments, other resilient materials (e.g., polymeric materials such as polyurethane or the like) may be used for these parts and/or that these components may alternatively use a resilient insert or cover over a metal or cast structure like prior versions of mount 160a if such a configuration is desired or preferred.

In the exemplary embodiments of the invention disclosed herein, the snap-fit clamp provides a three-hundred sixty degree (360°) boltless or pinless (fastenerless) clamp that secures the actuator to the frame and prevents removal of the actuator in all three-hundred sixty degrees (360°) around the frame to prevent accidental or inadvertent removal. In other words, a self-contained 360° clamp is provided to secure the actuator without the need for additional pins, bolts or fasteners. The clamp member is formed with integral securing structures that mate with corresponding securing structures on the actuator mount or bushing without requiring excessive force applied to the actuator 140. In alternate forms, the clamping structures may be designed to secure an amount of the frame less than 360°, but more than the friction fit structure of the '302 patent. For example, clamp member 150 and bushing or mount could be designed to encircle between 200°-360° of the frame, and preferably, 270°-360° of the outer circumference or periphery of the frame portion to which the actuator is connected. It should also be understood that many of these embodiments may be used with different types of articulating furniture designs, such as the four point articulated bed system of FIGS. 4A-B.

It should also be understood that in addition to the various snap-fit clamp embodiments disclosed herein, there have also been disclosed numerous methods relating to apparatus for securing actuators to structures. For example, a new method for securing an actuator to a structure, such as a frame of articulated furniture, has been disclosed comprising providing a first clamp member connected to an actuator and having a first mating structure, and a second snap-fit clamp member having a second mating structure that engages and mates with the first mating structure when the second clamp member is snapped onto the first clamp member. This design forms a clamp that secures the actuator to a structure such as the frame of articulated furniture and encloses at least 200° of the outer circumference or periphery of the structure so that the actuator is easily and properly connected to the structure. More preferably, the first and second clamp members mate to secure the first end 142 or motor end of the actuator 140 to a part such as a frame member. As explained above, the second snap-fit clamp member (e.g., 150) is movable between a first position wherein the second snap-fit clamp member is spaced apart from the first clamp member (e.g., 152) and a second position wherein the second snap-fit clamp member is snapped onto the first clamp structure. The method further comprising securing the actuator to the structure by enclosing a portion of the structure between the first and second clamp members via the snap-fit connection made between the first and second clamp members when the second clamp member is in the second position.

Another method disclosed herein is a method for moving articulated furniture comprising providing an actuator having a motor coupled to a transmission and a power supply, the transmission driving a drive tube that is connected to a structure for moving articulated furniture and having a housing for covering the transmission, and a clamp for connecting the actuator to the articulated furniture. The clamp preferably having a first clamp member that is connected to the actuator, such as being coupled to the transmission housing, and a second clamp member that is movable between a first position wherein the second clamp member is spaced apart from the first clamp member and a second position wherein the second clamp member is snap-fit onto the first clamp member to form a clamp that encloses a portion of the articulated furniture and secures the actuator to the articulated furniture so that the actuator is easily and properly connected to the articulated furniture. The method further comprises securing the actuator to the articulated furniture via the clamp and operating the actuator to move at least a portion of the articulated furniture.

When considering the material incorporated by reference from the '302 patent in combination with the material disclosed herein, another method for moving an adjustable bed is disclosed comprising providing a stationary base having a pair of opposed side rails, a head end rail and a foot end rail, a frame spaced above said stationary base and movable relative to said stationary base and an articulated deck comprising a head deck board, a seat deck board, a leg deck board and a foot deck board hingedly joined to each other, said seat deck board being fixedly secured to said frame. The method further comprising providing head links of a fixed length pivotally secured to said side rails of said base and pivotally secured to brackets secured to said head deck board, and a pair of motorized linear actuator assemblies for moving said frame relative to said stationary base. Each of said motorized linear actuator assemblies comprising a linear actuator having one end connected by a first snap-fit connector to a cross member of said movable frame and an opposite end connected by a second connector to a component operative when moved to effect movement of at least one of said head, leg and foot deck boards between said horizontal position and said inclined position wherein said second connector is a snap-fit connector (see the '302 patent) that has a slot adapted to receive a pin extending between a pair of link arms operatively coupled to a rotatable torque tube of said frame and said first snap-fit connector having a first clamp member fixed to a portion of the actuator and a second clamp member movable between a first position wherein the second clamp member is spaced apart from the first clamp member so that the actuator may be removed from the cross member of said movable frame and a second position wherein the second clamp member is snap-fit to the cross member of said movable frame in order to secure the actuator to the movable frame, the first and second clamp members enclosing the cross member of said movable frame to ensure the actuator (and particularly the first end or motor end of the actuator) is properly secured to the cross member of said movable frame. In such other embodiments, the method may further comprise securing both ends of the linear actuators to the cross members of the movable frame via the first and second clamp members of the snap-fit connectors disclosed herein, and operating the linear actuators to move portions of the adjustable bed. In other words, both ends of the actuator may be secured to articulated furniture using 360° clamps like those disclosed in FIGS. 1A-7C.

In summary, many different embodiments and methods have been disclosed herein and even more embodiments and methods are contemplated by the disclosure set forth herein. It should be understood that changes may be made to the embodiments disclosed herein while still operating within the concepts contemplated as the invention. For example, parts of different size, shape, location or number may be used in keeping with the invention and/or various parts of one embodiment may be combined with other embodiments to come-up with a variety of different embodiments in keeping with the invention disclosed herein. For example, although some embodiments discussed herein mention using a snap-fit clamp having first and second clamp members each with first and second mating structures, it should be understood that in alternate embodiments any number of mating structures may be used as is desired for a particular application. Similarly, additional clamp members may be used to make-up the clamp that encloses the structure for anchoring the actuator to the articulated furniture. As also mentioned above, numerous patents cover alternate apparatus and methods for securing actuators to structures such as articulated furniture. These disclosures detail various alternate types of furniture, furniture construction and actuator systems that can be used with same. Rather than repeating all of these different embodiments in this disclosure, Applicants hereby incorporate by reference U.S. Pat. No. 3,921,230 issued to Hanning et al. on Nov. 25, 1975, U.S. Pat. No. 4,381,571 issued to Elliott on May 3, 1983, U.S. Pat. No. 4,678,231 issued to Chizek on Jul. 7, 1987, U.S. Pat. No. 4,928,332 issued to Ogden et al. on May 29, 1990, U.S. Pat. No. 5,063,623 issued to Bathrick et al. on Nov. 12, 1991, U.S. Pat. No. 5,094,508 issued to Bathrick et al. on Mar. 10, 1992, U.S. Pat. No. 5,219,204 issued to Bathrick et al. on Jun. 15, 1993, U.S. Pat. No. 5,438,723 issued to Carroll on Aug. 8, 1995, U.S. Pat. No. 5,542,744 issued to Bathrick on Aug. 6, 1996, U.S. Pat. No. 5,579,550 issued to Bathrick et al. on Dec. 3, 1996, U.S. Pat. No. 6,061,852 issued to Bathrick et al. on May 16, 2000 and U.S. Pat. No. 7,900,302 issued to Long on Mar. 8, 2011 (hereinafter collectively referred to as “the incorporated patents”), to keep the size of this application reasonable, but it should be understood that the snap-fit clamp disclosed herein may be used with any of the apparatus, methods or systems disclosed in the incorporated patents to secure either or both ends of the actuator (e.g., 142, 144) and the claims presented herein are intended to cover same.

1. An apparatus for securing an actuator to a structure comprising:
a first clamp member connected to an actuator and having a first mating structure; and
a second snap-fit clamp member having a second mating structure that engages and mates with the first mating structure when the second clamp member is snapped onto the first clamp member to form a clamp that secures the actuator to a structure and encloses the structure so that the actuator is easily and properly connected to the structure, the second snap-fit clamp member being movable between a first position wherein the second snap-fit clamp member is spaced apart from the first clamp member and a second position wherein the second snap-fit clamp member is snapped onto the first clamp structure.

2. The apparatus of claim 1 wherein the first clamp member defines a semi-circular surface and the first mating structure comprises first structures positioned on opposite sides of the first clamp member, and the second snap-fit clamp member is generally U-shaped with the second mating structure comprising second structures positioned proximate to distal ends of the U-shaped second snap-fit clamp member which each engage and mate with a respective first structure of the first clamp member when the second snap-fit clamp member is in the second position, the distal ends of the second clamp member capable of flexing as the second clamp member is moved toward the second position and the second clamp member snapping into engagement with the first clamp member once the second position has been reached.

3. The apparatus of claim 1 wherein the first mating structure comprises an aperture defined by the first clamp member and the second mating structure comprises a projection for being disposed in the aperture defined by the first clamp member when the second clamp member is in the second position.

4. The apparatus of claim 3 wherein the aperture extends through the first clamp member defining openings on opposite ends of the first clamp member which make-up at least a portion of the first mating structure, and the second clamp member having a general U-shape with the projection of the second clamp member comprising a plurality tubular structures extending from opposite ends of the U-shaped second clamp member and being tapered so as to allow the second clamp structure to be easily slid onto the first clamp member until reaching the second position wherein tubular structures are disposed in the openings defined by the first clamp member.

5. The apparatus of claim 4 wherein the first clamp member defines a semi-circular surface and includes a bushing that covers at least a portion of the semi-circular surface and together with the second clamp member defines a generally circular opening with a generally constant inner diameter when the second clamp member is snap-fit into the second position.

6. The apparatus of claim 5 wherein the bushing defines a first guide for aligning and guiding the ends of the U-shaped second clamp member as the second clamp member is moved from the first position to the second position to assist in making sure the tubular structures of the second clamp member get aligned with and disposed in the openings of the first clamp member when the second clamp member is in the second position.

7. The apparatus of claim 6 wherein the first clamp member defines a second guide positioned proximate to the first guide defined by the bushing which works in concert with the first guide to aligning and guiding the ends of the U-shaped second clamp member as the second clamp member is moved from the first position to the second position to further assist in making sure the tubular structures of the second clamp member get aligned with and disposed in the openings of the first clamp member when the second clamp member is in the second position.

8. The apparatus of claim 7 wherein the first guide is a first channel defined by upstanding walls of the bushing and the second guide is a second channel defined by recessed grooves located on opposite sides of the first clamp member extending from the first channel to the openings defined by the first clamp member.

9. The apparatus of claim 5 wherein at least one of the first clamp member and bushing define a guide for aligning and guiding a portion of the second clamp member while it is moved from the first position to the second position.

10. An actuator for moving articulated furniture comprising:
an actuator having a motor coupled to a transmission and a power supply, the transmission driving a drive tube that is connected to a structure for moving articulated furniture and having a housing for covering the transmission; and
a clamp for connecting the actuator to the articulated furniture, the clamp having a first clamp member that is connected to the transmission housing and a second clamp member that is movable between a first position wherein the second clamp member is spaced apart from the first clamp member and a second position wherein the second clamp member is snap-fit onto the first clamp member to form a clamp that fully encircles a portion of the articulated furniture and secures the actuator to the articulated furniture so that the actuator is easily and properly connected to the articulated furniture.

11. An adjustable bed comprising:
a stationary base having a pair of opposed side rails, each of said side rails including a channel having a “C-shaped” cross-sectional configuration;
a frame movable relative to said stationary base, said frame including a pair of side assemblies and a pair of cross members;
rollers rotatably mounted to said side assemblies of said frame and being rotatable in said channels of said side rails of said base;
a seat deck board secured to said movable frame;
a head deck board hingedly secured to said seat deck board;
a leg deck board hingedly secured to said seat deck board;
a foot deck board hingedly secured to said leg deck board;
a pair of head links of a fixed length, each of said head links being pivotally secured to one of said side rails of said base at one end and being pivotally secured to brackets secured to said head deck board at the other end;
a pair of leg links of a fixed length, each of said leg links being pivotally secured to said frame at one end and being pivotally secured to brackets secured to said leg deck board at the other end;
a first motorized linear actuator assembly secured by at least one snap-fit connector to said frame, said first motorized linear actuator assembly including a motor, a housing, a housing tube, an extension tube movable relative to said housing tube, and wherein the first snap-fit connector having a first clamp member fixed to the housing of the actuator and a second clamp member movable between a first position wherein the second clamp member is spaced apart from the first clamp member so that the actuator may be removed from the adjustable bed and a second position wherein the second clamp member is snap-fit to the first clamp member and surrounds at least a portion of one of said cross members of said frame in order to ensure the snap-fit clamp and actuator is properly secured to the one of said cross members.

12. The adjustable bed of claim 11 further comprising a second motorized linear actuator assembly secured by a second snap-fit connector to said frame, said second motorized linear actuator assembly including a housing tube and an extension tube movable relative to said housing tube, said second snap-fit connector having a first clamp member fixed to the housing of the actuator and a second clamp member movable between a first position wherein the second clamp member is spaced apart from the first clamp member of the second snap-fit connector so that the second actuator may be removed from the adjustable bed and a second position wherein the second clamp member of the second snap-fit connector is snap-fit to one of said cross members of said frame in order to ensure the snap-fit clamp is properly secured to the one of said cross members.

13. An adjustable bed comprising:
a stationary base having a pair of opposed side rails, a head end rail and a foot end rail;
a frame spaced above said stationary base and movable relative to said stationary base;
an articulated deck comprising a head deck board, a seat deck board, a leg deck board and a foot deck board hingedly joined to each other, said seat deck board being fixedly secured to said frame;
head links of a fixed length pivotally secured to said side rails of said base and pivotally secured to brackets secured to said head deck board; and
a pair of motorized linear actuator assemblies for moving said frame relative to said stationary base, each of said motorized linear actuator assemblies comprising a linear actuator having one end connected by a snap-fit connector to a cross member of said movable frame and an opposite end connected by a second connector to a component operative when moved to effect movement of at least one of said head, leg and foot deck boards between said horizontal position and said inclined position wherein said second snap-fit connector has a slot adapted to receive a pin extending between a pair of link arms operatively coupled to a rotatable torque tube of said frame and said snap-fit connector having a first clamp member fixed to a portion of the actuator and a second clamp member movable between a first position wherein the second clamp member is spaced apart from the first clamp member so that the actuator may be removed from the cross member of said movable frame and a second position wherein the second clamp member is snap-fit to the cross member of said movable frame in order to secure the actuator to the movable frame, the first and second clamp members enclosing the cross member of said movable frame to ensure the actuator is properly secured to the cross member of said movable frame.

14. A method for securing an actuator to a structure comprising:
providing a first clamp member connected to an actuator and having a first mating structure, and a second snap-fit clamp member having a second mating structure that engages and mates with the first mating structure when the second clamp member is snapped onto the first clamp member to form a clamp that secures the actuator to a structure and encloses the structure so that the actuator is easily and properly connected to the structure, the second snap-fit clamp member being movable between a first position wherein the second snap-fit clamp member is spaced apart from the first clamp member and a second position wherein the second snap-fit clamp member is snapped onto the first clamp structure; and
securing the actuator to the structure by enclosing a portion of the structure between the first and second clamp members via the snap-fit connection made between the first and second clamp members when the second clamp member is in the second position.

15. A method for moving articulated furniture comprising:
providing an actuator having a motor coupled to a transmission and a power supply, the transmission driving a drive tube that is connected to a structure for moving articulated furniture and having a housing for covering the transmission, and a clamp for connecting the actuator to the articulated furniture, the clamp having a first clamp member that is connected to the transmission housing and a second clamp member that is movable between a first position wherein the second clamp member is spaced apart from the first clamp member and a second position wherein the second clamp member is snap-fit onto the first clamp member to form a clamp that fully encloses a portion of the articulated furniture and secures the actuator to the articulated furniture so that the actuator is easily and properly connected to the articulated furniture;
securing the actuator to the articulated furniture via the clamp; and
operating the actuator to move at least a portion of the structure for moving articulated furniture.

16. A method for moving an adjustable bed comprising:
providing an adjustable bed according to claim 13;
securing the linear actuators to the cross members of the movable frame via the first and second clamp members of the snap-fit connectors; and
operating the linear actuators to move portions of the adjustable bed.
